(19) United States
(12) Patent Application Publication
(10) Pub. No.: US 2013/0093860 A1
(43) Pub. Date: Apr. 18, 2013

(54) 3DIMENSION STEREOSCOPIC DISPLAY DEVICE

(71) Applicants: Mitsuo Shimotani, Tokyo (JP); Makoto Mikuriya, Tokyo (JP); Takeo Sakairi, Tokyo (JP); Eriko Toma, Tokyo (JP)

(72) Inventors: Mitsuo Shimotani, Tokyo (JP); Makoto Mikuriya, Tokyo (JP); Takeo Sakairi, Tokyo (JP); Eriko Toma, Tokyo (JP)

(73) Assignee: MITSUBISHI ELECTRIC CORPORATION, Tokyo (JP)

(21) Appl. No.: 13/704,097

(22) PCT Filed: Oct. 20, 2010
(86) PCT No.: PCT/JP2010/006220

§ 371 Date: Dec. 13, 2012

(51) Int. Cl. H04N 13/04

(52) U.S. Cl. CPC H04N 13/04
USPC 348/51

(57) ABSTRACT

Disclosed is a 3Dimension stereoscopic display device including a stereoscopic display monitor 6 for displaying a right-eye image or video image and a left-eye image or video image for three-dimensional stereoscopic display, a three-dimensional touch panel 22 for detecting a relative three-dimensional position of a pointing object relative to a screen of the stereoscopic display monitor 6 or a touch surface thereof, a screen composition processing unit 4 for generating the right-eye image or video image and the left-eye image or video image for three-dimensional stereoscopic display in which a base screen and a virtual display surface R for three-dimensional stereoscopic display of an icon image which is an operation target are displayed at different screen positions in a three-dimensional stereoscopic manner, and a main CPU 4a for determining that the icon image is operated when the three-dimensional touch panel unit 22 detects a predetermined operation of the pointing object.

### FIELD OF THE INVENTION

The present invention relates to a 3Dimension stereoscopic display device that displays a three-dimensional stereoscopic image or a 3Dimension stereoscopic movie.

### BACKGROUND OF THE INVENTION

A conventional stereoscopic display device disclosed by patent reference 1 provides a three-dimensional stereoscopic image mainly intended for home use. Because this stereoscopic display device enables the user to watch a three-dimensional stereoscopic movie without wearing stereoscopic vision glasses, the stereoscopic display device offers high convenience to the user. For example, the stereoscopic display device is suitable for use as a content playback device or an RSE (Rear Seat Entertainment) display device for rear seats. The stereoscopic display device is also suitable for use in a control system using FA (Factory Automation) or image display.

### RELATED ART DOCUMENT

### Patent Reference

Patent reference 1: Japanese Unexamined Patent Application Publication No. 2005-175566

### SUMMARY OF THE INVENTION

However, a problem which arises in a case in which a conventional technology, typified by a technology disclosed in patent reference 1, is applied to a three-dimensional stereoscopic display of an icon or a button is that there is a possibility that a user operation performed on an icon or the like displayed in a three-dimensional stereoscopic manner is not accepted because no correspondence between a virtual position space in which the icon or the button is displayed in a three-dimensional stereoscopic manner and an operation input unit for actually accepting an operation on the icon or the button is clearly defined. More specifically, because the virtual display of the icon or the button in a three-dimensional stereoscopic manner and a hardware switch or touch panel surface for actually accepting an operation on the icon or the button exist at different positions or in different spaces, the conventional technology makes the user have a feeling that something is abnormal.

The present invention is made in order to solve the above-mentioned problem, and it is therefore an object of the present invention to provide a 3Dimension stereoscopic display device that can provide an HMI (Human Machine Interface) with a three-dimensional stereoscopic display which enables the user to perform an operation matching the user's intuition.

In accordance with the present invention, there is provided a 3Dimension stereoscopic display device including: a stereoscopic display monitor unit for displaying a right-eye image or video image and a left-eye image or video image for three-dimensional stereoscopic display of an operation screen in a three-dimensional stereoscopic manner; a touch panel unit disposed on a screen of the stereoscopic display monitor unit, for detecting a relative position of a pointing object relative to a touch surface thereof, the pointing object being used for performing a touch operation on the operation screen which is displayed on the screen of the stereoscopic display monitor unit in a three-dimensional stereoscopic manner; a screen composition processing unit for generating the right-eye image or video image and the left-eye image or video image for three-dimensional stereoscopic display in which a virtual display surface for three-dimensional stereoscopic display of an icon image which is an operation target on the operation screen is set to be placed at a position forward with respect to the screen of the stereoscopic display monitor unit; and a control unit for determining that the icon image is operated when the touch panel unit detects a pointing object used for performing a touch operation on the icon image.

According to the present invention, there is provided an advantage of being able to provide an HMI with a three-dimensional stereoscopic display which enables a user to perform an operation matching the user's intuition.

### BRIEF DESCRIPTION OF THE FIGURES

FIG. 1 is a block diagram showing an example of the structure of a stereoscopic display system which uses a 3Dimension stereoscopic display device in accordance with the present invention;

FIG. 2 is a view for explaining the principle behind a stereoscopic display in a stereoscopic display monitor;

FIG. 3 is a block diagram showing the structure of an in-vehicle information system which uses the 3Dimension stereoscopic display device in accordance with Embodiment 1 of the present invention;

FIG. 4 is a view showing the structure of a three-dimensional touch panel;

FIG. 5 is a view for explaining a screen compositing process of placing a virtual display of a planar map at a position backward with respect to a touch surface of the three-dimensional touch panel;

FIG. 6 is a view showing a data flow in the screen compositing process shown in FIG. 5;

FIG. 7 is a flow chart showing a flow of the screen compositing process carried out by the 3Dimension stereoscopic display device in accordance with Embodiment 1;

FIG. 8 is a view for explaining a screen compositing process of placing a virtual display of a planar map at a position backward with respect to the touch surface, and placing a virtual display surface of icons at a position forward with respect to the touch surface;

FIG. 9 is a view showing a data flow in the screen compositing process shown in FIG. 8;

FIG. 10 is a view showing an example 1 of display of stereoscopic image icons according to a user operation;

FIG. 11 is a view showing an example 2 of the display of the stereoscopic image icons according to a user operation; and

FIG. 12 is a view showing an example 3 of the display of a stereoscopic image icon according to a user operation.

### EMBODIMENTS OF THE INVENTION

Hereafter, in order to explain this invention in greater detail, the preferred embodiments of the present invention will be described with reference to the accompanying drawings.

### Embodiment 1

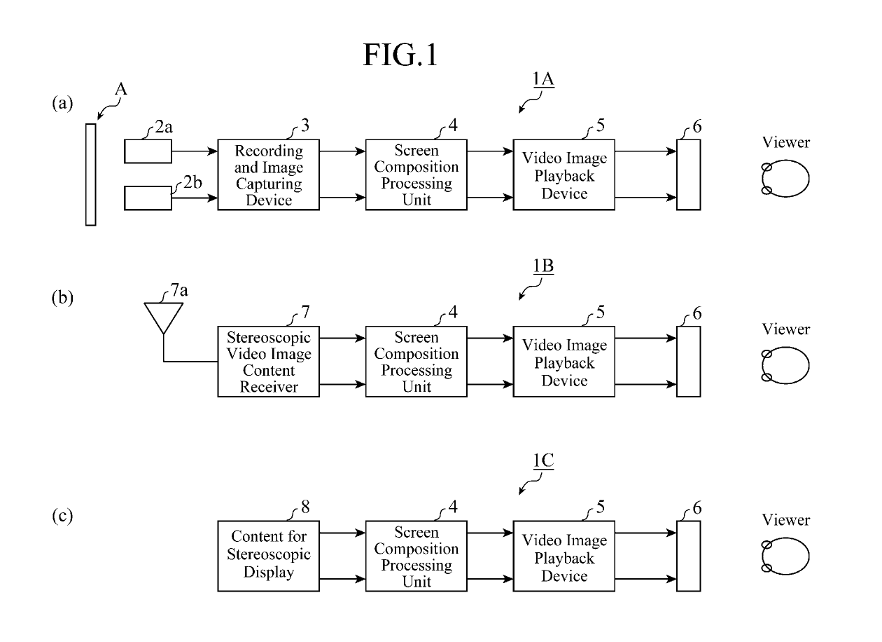

FIG. 1 is a block diagram showing an example of the structure of a stereoscopic display system which uses a 3Dimension stereoscopic display device in accordance with the present invention. FIG. 1(a) shows the stereoscopic display system 1A which displays a stereoscopic video image on the basis of right and left video images captured using cameras for both eyes. Referring to FIG. 1(a), the stereoscopic display system 1A is provided with a left-eye camera 2a, a right-eye camera 2b, a recording and image capturing device 3, a screen composition processing unit 4, a video image playback device 5, and a stereoscopic display monitor 6. The left-eye camera 2a and the right-eye camera 2b are arranged at an interval which takes into consideration the parallax difference between the two eyes, and capture a scene A which is an object to be captured under control of the recording and image capturing device 3. Right and left video data about the scene A captured by the left-eye camera 2a and the right-eye camera 2b are recorded in the recording and image capturing device 3. The screen composition processing unit 4 carries out a three-dimensional stereoscopic video image compositing process on the right and left video data read from the recording and image capturing device 3, the three-dimensional stereoscopic movie composite process being specific to the present invention, and outputs the right and left video data processed thereby to the video image playback device 5. The video image playback device 5 plays back the right and left video data processed by the screen composition processing unit 4, and then outputs the right and left video data played back thereby to the stereoscopic display monitor 6. The stereoscopic display monitor 6 displays the right and left video data played back by the video image playback device 5 in a stereoscopic manner when viewed from a viewer.

A stereoscopic display system 1B shown in FIG. 1(b) is provided with a stereoscopic video image content receiver 7 which communicates with an external device via an antenna 7a, an image composition processing unit 4, a video image playback device 5, and a stereoscopic display monitor 6. The stereoscopic video image content receiver 7 receives a stereoscopic video image content including right and left video data as mentioned above from the external device via the antenna 7a. The screen composition processing unit 4 carries out a three-dimensional stereoscopic video image compositing process on the right and left video data included in the stereoscopic video image content received by the stereoscopic video image content receiver 7, the three-dimensional stereoscopic video image compositing process being specific to the present invention, and outputs the right and left video data processed thereby to the video image playback device 5. The stereoscopic display monitor 6 displays the right and left video data played back by the video image playback device 5 in a stereoscopic manner when viewed from a viewer, like that shown in FIG. 1(a).

A stereoscopic display system 1C shown in FIG. 1(c) is provided with a storage unit 8 for storing a content for stereoscopic display, an image composition processing unit 4, a video image playback device 5, and a stereoscopic display monitor 6. The content for stereoscopic display is content data including right and left video data as mentioned above. As the storage unit 8, an HDD (Hard Disk Drive) or a semiconductor memory for storing the content for stereoscopic display can be provided. As an alternative, a drive device for playing back a memory medium, such as a CD or a DVD, for storing the content for stereoscopic display can be provided.

The screen composition processing unit 4 carries out a three-dimensional stereoscopic video image compositing process on the right and left video data in the content for stereoscopic display read from the storage unit 8, the three-dimensional stereoscopic video image compositing process being specific to the present invention, and outputs the right and left video data processed thereby to the video image playback device 5. The stereoscopic display monitor 6 displays the right and left video data played back by the video image playback device 5 in a stereoscopic manner when viewed from a viewer, like that shown in FIG. 1(a). So-called three-dimensional data (e.g. three-dimensional map data) can be stored as the content for stereoscopic display, and the screen composition processing unit 4 can compute how the image shown by this three-dimensional data appears from each of the left and right points of view to generate right and left video data.

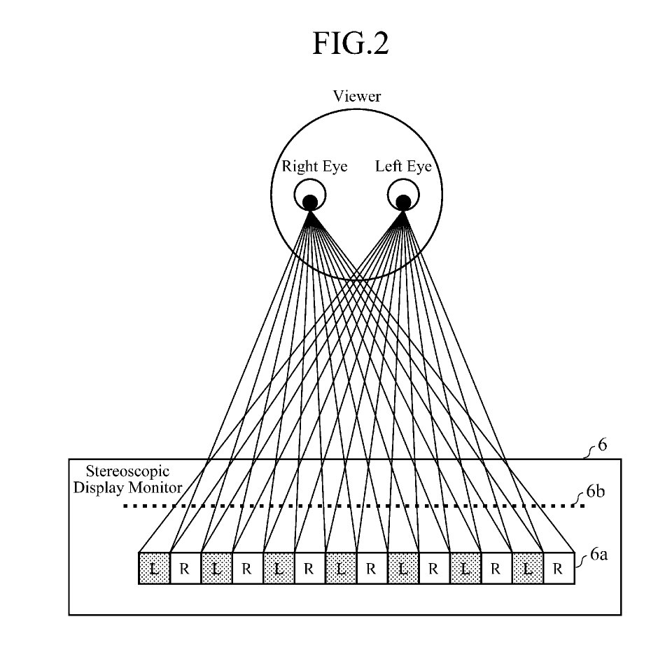

FIG. 2 is a view for explaining the principle behind a stereoscopic display produced by the stereoscopic display monitor, and shows an example of a stereoscopic display intended for the naked eye. The stereoscopic display monitor 6 shown in FIG. 2 is provided with a liquid crystal display element group 6a and a parallax barrier unit 6b. The liquid crystal display element group 6a has a liquid crystal element group for right eyes which provides directivity for causing a right-eye video image to reach a right eye, and a liquid crystal element group for left eyes which provides directivity for causing a left-eye video image to reach a left eye. The parallax barrier unit 6b is a visual field barrier for blocking light from a backlight (not shown in FIG. 2) in order to alternately display the right-eye video image and the left-eye video image.

A video signal for left eyes (L) and a video signal for right eyes (R) which the video image playback device 5 generates by playing back the right and left video data are alternately inputted to the stereoscopic display monitor 6 in order of L, R, L, R, and . . . . When receiving the video signal for left eyes (L), the liquid crystal display element group 6a operates the liquid crystal element group for left eyes, whereas when receiving the video signal for right eyes (R), the liquid crystal display element group 6a operates the liquid crystal element group for right eyes. The parallax barrier unit 6b blocks the light emitted from the backlight and passing through the liquid crystal display element group for right eyes at the time that the liquid crystal element group for left eyes operates, whereas the parallax barrier unit 6b blocks the light emitted from the backlight and passing through the liquid crystal display element group for left eyes at the time that the liquid crystal element group for right eyes operates. As a result, the right-eye video image and the right-eye video image are displayed alternately on the screen of the stereoscopic display monitor 6, so that a viewer can watch the stereoscopic video image at his or her point of view shown in FIG. 2.

The present invention is not limited to the stereoscopic display monitor 6 having the structure shown in FIG. 2, and a monitor which implements stereoscopic vision by using another mechanism can be alternatively used. For example, a method of providing a stereoscopic image by causing a viewer to wear glasses having left and right lenses to which different polarizing plates are attached as exclusive glasses can be used.

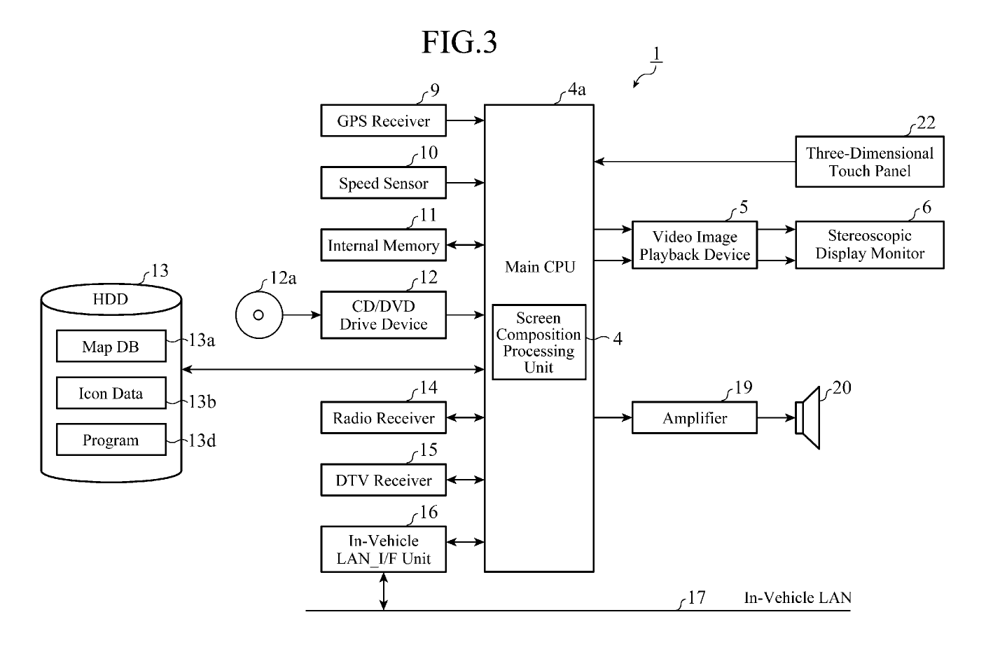

FIG. 3 is a block diagram showing the structure of an in-vehicle information system which uses the 3Dimension stereoscopic display device in accordance with Embodiment 1 of the present invention. In the example shown in FIG. 3, the in-vehicle information system 1 functions as a stereoscopic display system shown in FIG. 1, regarding a display of an image, such as a map or a video image. Further, the in-vehicle information system 1 is provided with a main CPU (control unit) 4a, a video image playback device 5, a stereoscopic display monitor (stereoscopic display monitor unit) 6, a GPS (Global Positioning System) receiver 9, a speed sensor 10, an internal memory 11, a CD/DVD drive device 12, an HDD 13, a radio receiver 14, a DTV receiver 15, an in-vehicle LAN_I/F unit 16, an amplifier 19, a speaker 20, and a three-dimensional touch panel 22.

The main CPU 4a controls each component disposed in the in-vehicle information system 1. This main CPU 4a functions as the screen composition processing unit 4 shown in FIG. 1 by executing a program 13d (application program for in-vehicle information processing) stored in the HDD 13. The video image playback device 5 plays back the right and left video data on which the screen composition processing unit 4 of the main CPU 4a has carried out a compositing process, and outputs the right and left video data played back thereby to the stereoscopic display monitor 6. Further, the stereoscopic display monitor 6 displays the right and left video data played back by the video image playback device 5 in a stereoscopic manner when viewed from a viewer.

The GPS receiver 9 receives the position information about the position of the vehicle from GPS satellites, and the speed sensor 10 detects vehicle speed pulses for calculating the vehicle speed of the vehicle. The internal memory 11 serves as a work area when the main CPU 4a executes the application program for in-vehicle information processing. The CD/DVD drive device 12 plays back an AV source stored in a memory medium 12a, such as a CD or DVD. When stereoscopic display video data are included in an AV source stored in the memory medium 12a, the CD/DVD drive device functions as the stereoscopic video image content receiver 7 shown in FIG. 1(b), and the in-vehicle information system 1 functions as the stereoscopic display system 1B shown in FIG. 1(b).

The HDD (hard disk drive) 13 is a mass storage device mounted in the in-vehicle information system 1, and stores a map database (abbreviated as a map DB hereafter) 13a, icon data 13b, and a program 13d. The map DB 13a is a database in which map data for use in navigation processing are registered. POI information in which the locations of POIs (Points Of Interest) on a map or detailed information associated with these POIs are described is also included in the map data. The icon data 13b show icons which are to be displayed on the screen of the stereoscopic display monitor 6. The icon data include icons showing operation buttons used for enabling the user to carry out various operations on the screen, etc. The program 13d is an application program for in-vehicle information processing which the main CPU 4a executes. For example, the program has an application program for map display including a program module for implementing the functions of the screen compositing process unit 4.

The radio receiver 14 receives a radio broadcast, and makes a channel selection according to, for example, an operation on a not-shown button selector. The DTV receiver 15 receives a digital television broadcast, and makes a channel selection according to an operation on a not-shown button selector, like the radio receiver 14. The DTV receiver 15 also functions as the stereoscopic video image content receiver 7 shown in FIG. 1(b) when three-dimensional stereoscopic display video data are included in a digital television broadcast received thereby, and the in-vehicle information system 1 functions as the stereoscopic display system 1B shown in FIG. 1(b).

The in-vehicle LAN_I/F unit 16 is an interface between an in-vehicle LAN (Local Area Network) 17 and the main CPU 4a, and relays data communications between, for example, other equipment connected to the in-vehicle LAN 17, and the main CPU 4a. Further, the storage unit 8 shown in FIG. 1(c) is connected to the in-vehicle LAN 17, and, when the in-vehicle LAN_I/F unit 16 is regarded as a component for relaying between this storage unit 8 and the screen compositing process unit 4 of the main CPU 4a, the in-vehicle information system 1 functions as the stereoscopic display system 1C shown in FIG. 1(c).

Sound signals played back by the CD/DVD drive device 12, the radio receiver 14, and the DTV receiver 15 and a sound signal from the main CPU 4a are amplified by the amplifier 19, and a sound is outputted via the speaker 20. As the sound signal from the main CPU 4a, there is a route guidance voice signal generated through the navigation processing, for example.

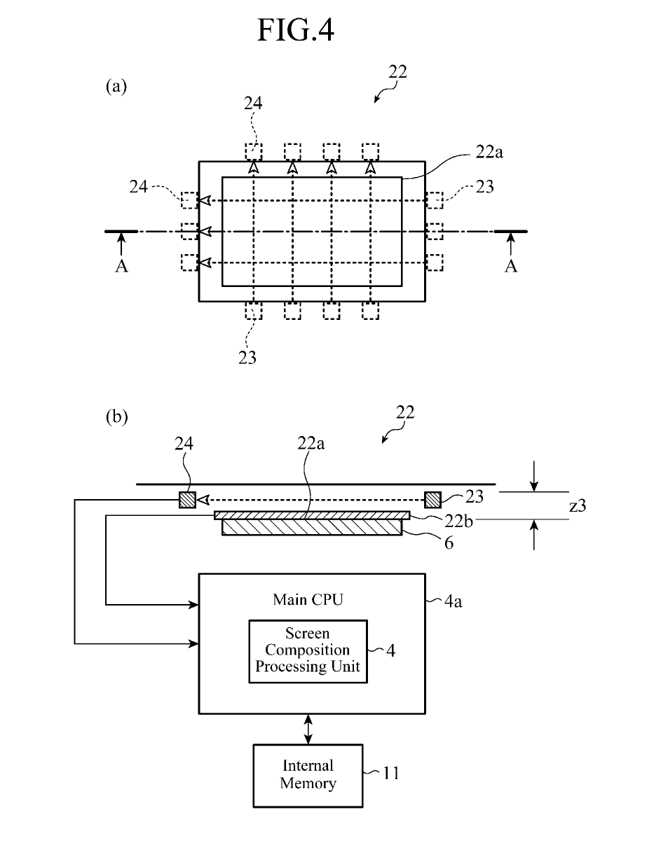

The three-dimensional touch panel 22 detects that a pointing object, such as a user's finger, reaches a region at a predetermined distance or less from a touch surface thereof in a noncontact manner, and also detects contact of a pointing object with the touch surface thereof. More specifically, the three-dimensional touch panel has three-dimensional space extending from the touch surface in the direction of the normal to the touch surface as its detection region. FIG. 4 is a view showing the structure of the three-dimensional touch panel, FIG. 4(a) shows a top plan view of the three-dimensional touch panel when viewed from the touch surface, and FIG. 4(b) shows a cross-sectional view taken along the line A-A of FIG. 4(a). The three-dimensional touch panel 22 is disposed on a display screen 22a of the stereoscopic display monitor 6, and, when the user pushes down the surface (touch surface) of the touch switch 22b by using a pointing object on the basis of information displayed on the display screen 22a, outputs coordinate data about a part of the surface pushed by the user to the main CPU 4a.

A plurality of infrared LEDs 23 are arranged along two sides which perpendicularly intersect each other and which are included in the periphery of the touch switch 22b, and a plurality of light receiving elements 24 each for receiving a corresponding one of infrared light rays from the plurality of infrared LED23 are arranged along two other sides opposite to the two sides along which the infrared LEDs 23 are arranged. In this arrangement, the infrared light rays emitted from the plurality of infrared LEDs 23 look as if they form a grid on the touch switch 22b, as shown in FIG. 4(a). Because the three-dimensional touch panel is constructed in this way, the three-dimensional touch panel can detect a pointing object that is going to touch the touch surface in the region at the distance z3 or less from the touch surface, and can also detect contact of a pointing object with the touch surface, as shown in FIG. 4(b).

Next, the operation of the 3Dimension stereoscopic display device will be explained.

### (1) Display of a Planar Map

The 3Dimension stereoscopic display device composites images into a three-dimensional stereoscopic image in which a virtual display of a planar image is placed at a position forward or backward with respect to the touch surface of the three-dimensional touch panel 22 (which is assumed to be at the same position as the screen of the stereoscopic display monitor 6) when viewed from a viewer's position, and displays the three-dimensional stereoscopic image in a stereoscopic manner. For example, when displaying a planar map in a map display in an in-vehicle navigation device, the 3Dimension stereoscopic display device places the virtual display of the planar map at a position backward with respect to the touch surface of the three-dimensional touch panel 22 (i.e., farther away from the driver than the touch surface). In this case, the 3Dimension stereoscopic display device can lessen the difference in focus distance between the focus position at which the road scene ahead of the vehicle at which the driver is looking while driving the vehicle is located, and the position of the virtual map display surface. More specifically, the 3Dimension stereoscopic display device enables the driver looking at an area ahead of the vehicle to direct his or her line of sight towards the touch surface of the three-dimensional touch panel 22 with a shorter travel distance of its focus position and view the map on the screen without having a feeling that something is abnormal. By doing in this way, the 3Dimension stereoscopic display device can make the map displayed in a stereoscopic manner legible, and, as a result, can improve the safety of the driver at the time of looking at the map display.

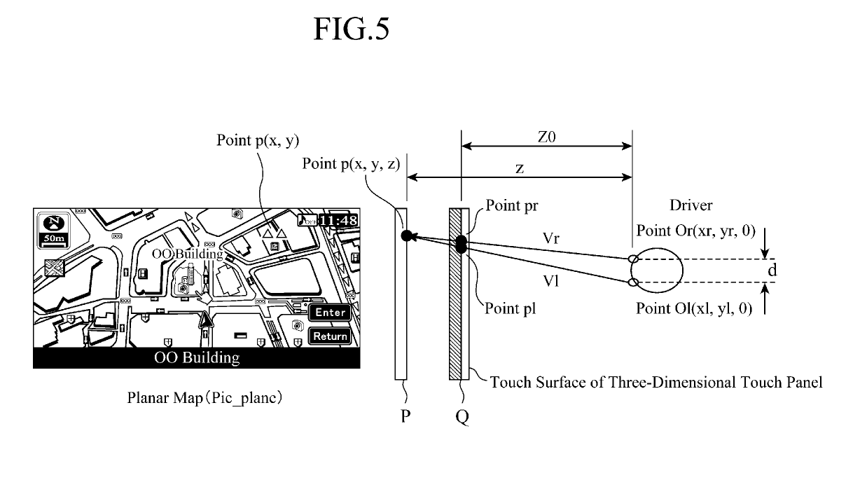

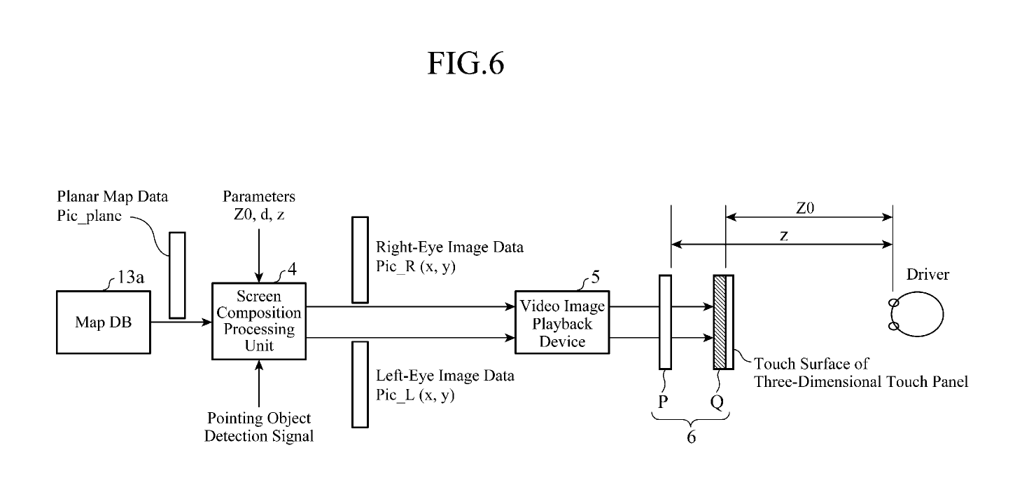

FIG. 5 is a view for explaining a screen compositing process of placing the virtual display of the planar map at a position backward with respect to the touch surface of the three-dimensional touch panel. FIG. 6 is a view showing a data flow in the screen compositing process shown in FIG. 5. First, the main CPU 4a reads map data from the map DB 13a stored in the HDD 13, and generates planar map data Pic_plane according to a predetermined map drawing algorithm, as shown in FIG. 6. The planar map data Pic_plane are the one about a planar map which is described in, for example, a left part of FIG. 5.

In the example shown in FIG. 5, the planar map shown by the planar map data Pic_plane is displayed on the virtual map display surface P placed at a position backward with respect to the touch surface of the three-dimensional touch panel 22. Hereafter, the distance from the position of the driver's eyes to the touch surface of the three-dimensional touch panel 22 is expressed as Z0, and the distance from the position of the driver's eyes to the virtual map display surface P is expressed as z. In the example shown in FIG. 5, the following relationship: z>Z0 is established.

Further, the position of the driver's right eye is expressed as a point Or (xr, yr, 0), the position of the driver's eye is expressed as a point O1(xl, yl, 0), and the gap between the left and right eyes is expressed as d. That is, the following relationship: |xr−xl|=d is established. The projection of a point p(x, y) on the planar map shown by the planar map data Pic_plane onto the virtual map display surface P yields a point p(x, y, z) on the map display surface P.

Right-eye image data Pic_R(x, y) of the planar map are expressed by a set of points pr at each of which a straight line (vector Vr) which connects between a point p(x, y, z) on the virtual map display surface P and the point Or(xr, yr, 0) which is the position of the right eye intersects the touch surface of the three-dimensional touch panel 22. Similarly, left-eye image data Pic_L(x, y) of the planar map are expressed by a set of points pl at each of which a straight line (vector V1) which connects between the point p(x, y, z) on the virtual map display surface P and the point O1 (xl, yl, 0) which is the position of the left eye intersects the touch surface of the three-dimensional touch panel 22.

The screen composition processing unit 4 calculates the points pr and pl by using the planar map data Pic_plane and the parameters Z0, z, and d in such a way that the distance between the virtual map display surface P and the position of each of the driver's right and left eyes is equal to z to generate right-eye image data Pic_R(x, y) and left-eye image data Pic_L (x, y), and outputs these right-eye and left-eye image data to the video image playback device 5.

The video image playback device 5 plays back the right-eye image data Pic_R(x, y) and the left-eye image data Pic_L(x, y) which are generated by the screen composition processing unit 4, and outputs them to the stereoscopic display monitor 6. The stereoscopic display monitor 6 displays the planar map in a stereoscopic manner by using the right-eye image data Pic_R(x, y) and the left-eye image data Pic_L(x, y) which are played back by the video image playback device 5. At this time, the 3Dimension stereoscopic display device makes the planar map look as if it is displayed on the virtual map display surface P placed at a position backward with respect to the touch surface of the three-dimensional touch panel 22 when viewed from the driver's position by using stereoscopic vision.

Further, when displaying a planar map in a map display in an in-vehicle navigation device, the 3Dimension stereoscopic display device can place the virtual display surface P of the planar map at a position forward with respect to the touch surface of the three-dimensional touch panel 22 (i.e., at a position closer to the driver than the touch surface). At this time, the 3Dimension stereoscopic display device makes the planar map look as if it is displayed to be floating from the touch surface of the three-dimensional touch panel 22 when viewed from the driver's position by using stereoscopic vision.

In the case of z<Z0, the 3Dimension stereoscopic display device makes the planar map shown by the planar map data Pic_plane look as if it is displayed on the virtual map display surface P placed at a position forward with respect to the touch surface of the three-dimensional touch panel 22 when viewed from the driver's position by using stereoscopic vision. As an alternative, when carrying out the screen compositing process with the following relationship: z=Z0, the 3Dimension stereoscopic display device makes the virtual map display surface P coincide with the touch surface of the planar map of the three-dimensional touch panel 22, and the planar map look as if it is displayed on the screen Q. As an alternative, when carrying out the screen compositing process with the following relationship: z>Z0, the 3Dimension stereoscopic display device makes the planar map look as if it is displayed on the virtual map display surface P placed at a position backward with respect to the touch surface of the three-dimensional touch panel 22 (i.e., farther away from the driver than the touch surface) when viewed from the driver's position by using stereoscopic vision.

Although in the above-mentioned explanation the case in which the present invention is applied to the in-vehicle information system 1 is shown, the application of the present invention is not limited to in-vehicle systems, and the present invention can be applied to all systems that require displays and operations, such as an FA, a panel computer, and a display system for guidance.

Further, in the case of z>Z0, when displaying the virtual map display surface P at a position farther away from the driver than the touch surface of the three-dimensional touch panel 22, the 3Dimension stereoscopic display device can improve the safety of the driver at a time when the driver looks at the map display, as mentioned above. In the case of z<Z0, the 3Dimension stereoscopic display device provides an advantage of making the screen legible by displaying the display screen in such a way that it is floating closer to the driver. Therefore, the 3Dimension stereoscopic display device can perform a control operation of setting the relationship between the parameters z and Z0 to z>Z0 when the vehicle is travelling, whereas the 3Dimension stereoscopic display device can perform a control operation of setting the relationship between the parameters z and Z0 to z<Z0 when the vehicle is at rest.

### (2) Display of a Planar Map and Icons

In the above-mentioned explanation, the case in which a planar map is displayed on a virtual map display surface P is shown. A case in which software buttons for operational input, such as icons, are displayed in a stereoscopic manner on another virtual display surface parallel to the virtual map display surface P will be mentioned hereafter.

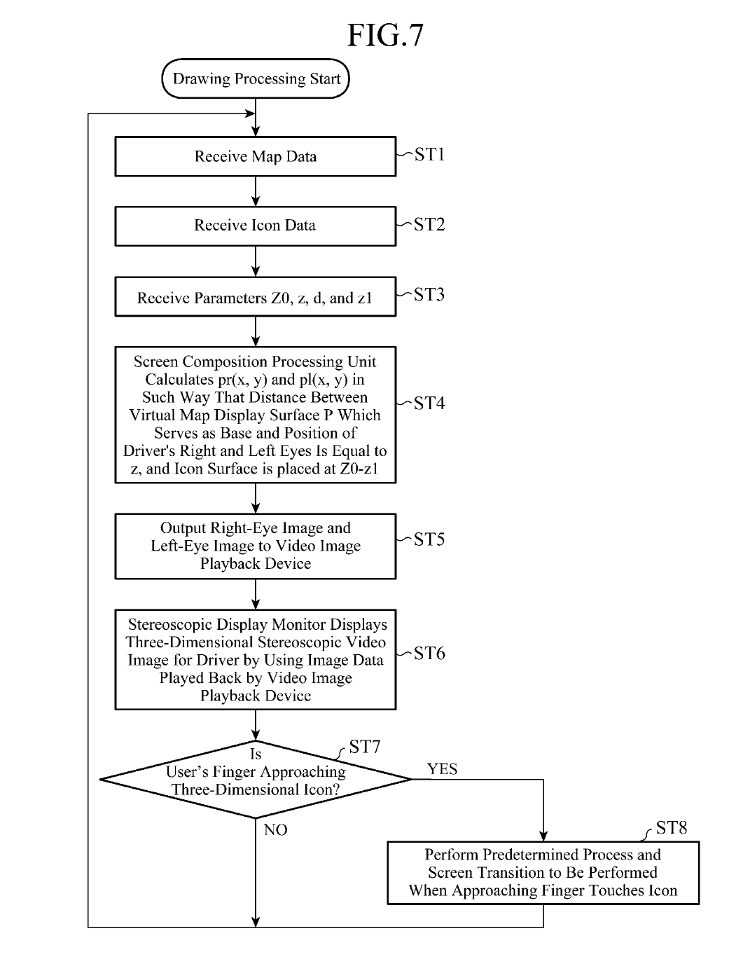

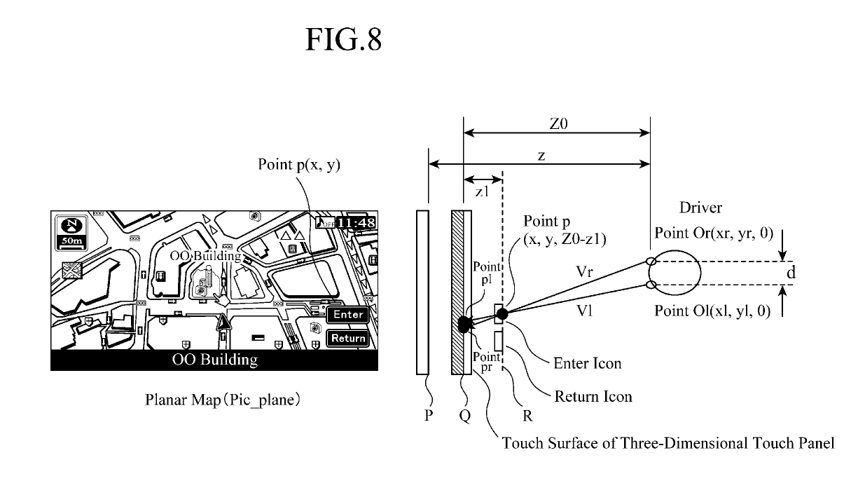

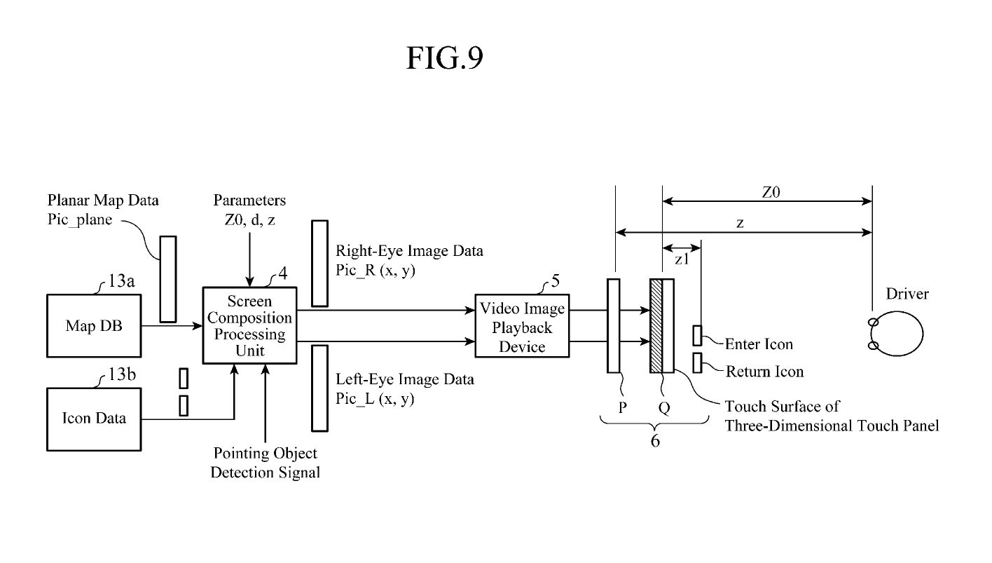

FIG. 7 is a flow chart showing a flow of a screen compositing process carried out by the 3Dimension stereoscopic display device in accordance with Embodiment 1. Further, FIG. 8 is a view for explaining a screen compositing process of placing the virtual display surface P of a planar map at a position backward with respect to the touch surface of the three-dimensional touch panel 22, and placing the virtual display surface R of icons at a position forward with respect to the touch surface of the three-dimensional touch panel 22. FIG. 9 is a view showing a data flow in the screen compositing process shown in FIG. 8.

First, the main CPU 4a reads map data from the map DB 13a stored in the HDD 13, and generates planar map data Pic_plane according to a predetermined map drawing algorithm, as shown in FIG. 9. The planar map data Pic_plane show the planar map which is described in, for example, a left part of FIG. 8. The main CPU 4a also reads icon data about icons which are to be superimposed on the planar map shown by the planar map data Pic_plane from icon data 13b stored in the HDD 13.

In this example, the 3Dimension stereoscopic display device displays the planar map shown by the planar map data Pic_plane on the virtual map display surface P which is placed at a position backward with respect to the touch surface of the three-dimensional touch panel 22, and displays an enter button and a return button on the virtual display surface R which is placed at a position forward with respect to the touch surface of the three-dimensional touch panel 22. Hereafter, the distance between the touch surface of the three-dimensional touch panel 22 and the display surface R of the icons is expressed as z1. More specifically, the 3Dimension stereoscopic display device makes each of the icons of the enter button and the return button look as if it is floating at the distance dz from the touch surface of the three-dimensional touch panel 22 with respect to the driver's position by using stereoscopic vision. In the example shown in FIG. 8, the distance Z0 between the position of the driver's eyes and the touch surface of the three-dimensional touch panel 22 (which is assumed to be at the same position as the screen of the stereoscopic display monitor 6) and the distance z between the position of the driver's eyes and the virtual map display surface P have the following relationship: z>Z0.

Right-eye image data Pic_R(x, y) of the planar map are expressed by a set of points pr at each of which a straight line (vector Vr) which connects between a point p(x, y, z) on the virtual map display surface P or a point p(x, y, Z0-z1) on the display surface R and the point Or(xr, yr, 0) which is the position of the right eye intersects the screen Q of the stereoscopic display monitor 6. Similarly, left-eye image data Pic_L(x, y) of the planar map are expressed by a set of points pl(xl, yl, Z0) at each of which a straight line (vector V1) which connects between the point p(x, y, z) on the virtual map display surface P or the point p(x, y, Z0-z1) on the display surface R and the point O1 (xl, yl, 0) which is the position of the left eye intersects the screen Q of the stereoscopic display monitor 6. On the other hand, each of the icons of the enter button and the return button in the right-eye image of the planar map is expressed by a set of points pr on the right-eye image, while each of the icons of the enter button and the return button in the left-eye image of the planar map is expressed by a set of points pl on the left-eye image.

The screen composition processing unit 4 receives the planar map data Pic_plane generated by the main CPU 4a (step ST1). Next, the screen composition processing unit 4 receives the icon data about the enter button and the return button which the main CPU 4a has read from the HDD 13 (step ST2). The screen composition processing unit 4 then receives the parameters Z0, z, d, and z1 from the internal memory 11 (step ST3).

The screen composition processing unit 4 then calculates the points pr and pl in such a way that the distance between the virtual map display surface P and the position of the driver's eyes is equal to z and the distance between the display surface R of the icons and the position of the driver's eyes is equal to (Z0-z1) by using the planar map data Pic_plane, the parameters Z0, z, d, and z1 and the icon data to generate right-eye image data Pic_R(x, y) and left-eye image data Pic_L(x, y) in the same way that the screen composition processing unit according to above-mentioned Embodiment 1 does (step ST4). After that, the screen composition processing unit 4 outputs the right-eye image data Pic_R(x, y) and the left-eye image data Pic_L(x, y) which are generated thereby to the video image playback device 5 (step ST5).

The video image playback device 5 plays back the right-eye image data Pic_R(x, y) and the left-eye image data Pic_L(x, y) which are generated by the screen composition processing unit 4, and outputs them to the stereoscopic display monitor 6. The stereoscopic display monitor 6 displays the planar map and the icons in a stereoscopic manner by using the right-eye image data Pic_R(x, y) and the left-eye image data Pic_L(x, y) which are played back by the video image playback device 5 (step ST6). At this time, the 3Dimension stereoscopic display device makes the enter button and the return button as if they are floating on the touch surface of the three-dimensional touch panel 22 with respect to the driver's position by using stereoscopic vision.

In the above-mentioned display state, the main CPU 4a determines whether or not the user's finger is approaching the touch surface of the three-dimensional touch panel 22 according to a detection signal from the three-dimensional touch panel 22 (step ST7). For example, when the user's finger moves and then enters the detection region defined by z3 and formed by the infrared LEDs 23 and the light receiving elements 24 in the three-dimensional touch panel 22, the three-dimensional touch panel 22 detects the coordinates of this finger as a point (x, y, z3). When the user's finger touches the touch surface, the three-dimensional touch panel 22 detects the coordinates of the finger as (x, y, 0), and outputs a detection signal showing the coordinates to the main CPU 4a. In the structure shown in FIG. 4, the infrared switch consisting of the infrared LEDs 23 and the light receiving elements 24 can determine whether a pointing object reaches the region at the distance z3 or less from the touch surface. By disposing two or more sets of infrared switches in parallel with the touch surface, the 3Dimension stereoscopic display device can measure the distance between a pointing object approaching the touch surface and the touch surface in steps.

When the three-dimensional touch panel determines that the user's finger is approaching the touch surface of the three-dimensional touch panel 22 (when YES in step ST7), the main CPU 4a carries out a predetermined process and a screen transition which are to be performed when a corresponding icon which the finger has approached is touched (step ST8). For example, when the user's finger is approaching the “return button,” the main CPU shifts to step ST8 and carries out a predetermined operation by assuming that the “return button” is pushed down and, after that, returns to the process of step ST1. Thus, the 3Dimension stereoscopic display device enables the user to simply operate a stereoscopic image icon which looks as if it is floating via stereoscopic vision in a noncontact manner to make the in-vehicle information system carry out the function corresponding to the operation. In contrast, when the three-dimensional touch panel determines that the user's finger not approaching the touch surface of the three-dimensional touch panel 22 (when NO in step ST7), the 3Dimension stereoscopic display device returns to the process of step ST1.

Further, the 3Dimension stereoscopic display device can generate a three-dimensional stereoscopic image in which the distance z1 at which the icon image is floating from the touch surface of the three-dimensional touch panel 22 via stereoscopic vision is made to be equal to the detection distance z3 at which a pointing object approaching the three-dimensional touch panel 22 is detected. By doing in this way, the 3Dimension stereoscopic display device can implement a user-friendly operation screen in which the display position of each icon coincides with the sensitivity area of the three-dimensional touch panel 22.

In addition, the case in which the virtual map display surface P of the planar map is placed at a position backward with respect to the touch surface of the three-dimensional touch panel 22 is shown in the above-mentioned explanation. In this case, because the 3Dimension stereoscopic display device makes each stereoscopic image icon look as if only this icon is floating from the touch surface via stereoscopic vision by making the map display surface P coincide with the touch surface of the three-dimensional touch panel 22 (z=Z0), the designability of the three-dimensional stereoscopic image is improved and the user is enabled to easily operate each stereoscopic image icon.

Further, the 3Dimension stereoscopic display device can set the parameters, such as z and z1, to the screen composition processing unit 4 through a user operation, and can change the already-set parameters through a user operation. For example, the 3Dimension stereoscopic display device enables the user to freely set the distance z1 at which each icon image is floating from the touch surface of the three-dimensional touch panel 22 via stereoscopic vision by performing a drag process of dragging the icon image along the z-axis of the three-dimensional touch panel 22 (in the direction of the normal to the touch surface).

In addition, the parameters, such as z and z1, can include a distance which is predetermined according to the state of the vehicle equipped with or holding the 3Dimension stereoscopic display device. As the distance which is predetermined according to the state of the vehicle equipped with or holding the 3Dimension stereoscopic display device, a distance which is predetermined according to the speed of the vehicle can be provided. More specifically, the 3Dimension stereoscopic display device can set preset values, as the map display surface P and the distance z1 between the touch surface of the three-dimensional touch panel 22 and the display surface R of the icons, to the screen composition processing unit 4 according to the speed of the vehicle. For example, the 3Dimension stereoscopic display device sets z to satisfy the following relationship: z>Z0 when the vehicle is travelling, whereas the device sets z to satisfy the following relationship: z=Z0 when the vehicle is at rest. Further, when the vehicle is travelling, the 3Dimension stereoscopic display device sets z1 to a smaller value than that when the vehicle is at rest.

As mentioned above, the 3Dimension stereoscopic display device in accordance with this Embodiment 1 includes the stereoscopic display monitor 6 for displaying a right-eye image or video image and a left-eye image or video image for three-dimensional stereoscopic display of an operation screen in a three-dimensional stereoscopic manner, the three-dimensional touch panel 22 disposed on the screen of the stereoscopic display monitor 6, for detecting a relative position of a pointing object relative to the touch surface thereof, the pointing object being used for performing a touch operation on the operation screen which is displayed on the screen of the stereoscopic display monitor 6 in a three-dimensional stereoscopic manner, the screen composition processing unit 4 for generating the right-eye image or video image and the left-eye image or video image for three-dimensional stereoscopic display in which the virtual display surface R for three-dimensional stereoscopic display of an icon image which is an operation target on the operation screen is set to be placed at a position forward with respect to the screen Q of the stereoscopic display monitor 6, and the main CPU 4a for determining that the icon image is operated when the three-dimensional touch panel unit 22 detects a pointing object used for performing a touch operation on the icon image. Because the 3Dimension stereoscopic display device is constructed in this way, the 3Dimension stereoscopic display device can provide an advantage of being able to provide an HMI with a three-dimensional stereoscopic display which enables the user to perform an operation matching the user's intuition.

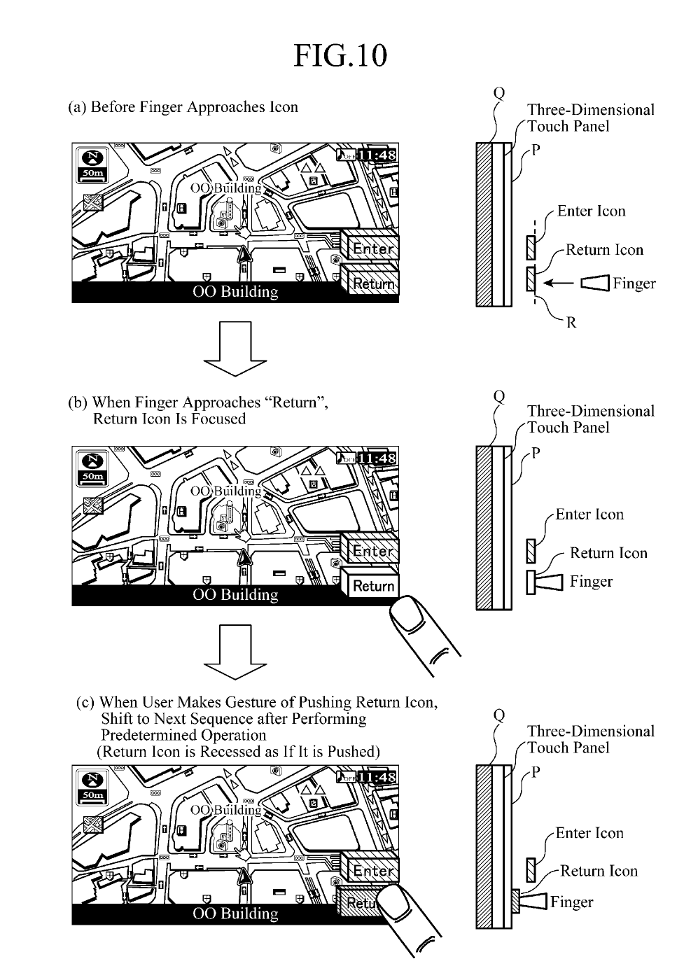

Further, the 3Dimension stereoscopic display device according to above-mentioned Embodiment 1 can display each stereoscopic image icon in the following way according to a user operation. FIG. 10 is a view showing an example 1 of the display of stereoscopic image icons according to a user operation. In the example shown in FIG. 10(a), the screen Q of the stereoscopic display monitor 6, the virtual map display surface P of the planar map, and the touch surface of the three-dimensional touch panel 22 are placed at the same position, and only the stereoscopic image icons of the enter button and the return button are displayed on the virtual display surface R. At this time, the enter button and the return button look as if they are floating from the touch surface of the three-dimensional touch panel 22 via stereoscopic vision with respect to the user's position.

When the user's finger approaches the “return button” in the display state shown in FIG. 10(a), and then a certain time period (e.g., 1 second) has elapsed in a state in which the user's finger is virtually in contact with the “return button,” the screen composition processing unit 4 generates a three-dimensional stereoscopic image in which the color of the stereoscopic image icon of the “return button” is changed, as shown in FIG. 10(b), and displays the “return button” in the changed color on the stereoscopic display monitor 6. As a result, the user can visually recognize that the “return button” is focused through the operation.

When the user then performs a gesture of further pushing the stereoscopic image icon of the “return button,” the three-dimensional touch panel 22 detects the travel distance of the finger caused by the gesture and then notifies this travel distance to the screen composition processing unit 4. The screen composition processing unit 4 changes the distance z1 between the virtual display surface R for display of the stereoscopic image icon of the “return button” and the touch surface according to the travel distance of the finger caused by the above-mentioned gesture to display the stereoscopic image icon of the “return button” in such a way that the stereoscopic image icon is recessed according to the gesture of pushing the stereoscopic image icon by using the finger, as shown in FIG. 10(c).

By doing in this way, the 3Dimension stereoscopic display device can provide an HMI which enables the user to perform an operation matching the user's intuition. As an alternative, the 3Dimension stereoscopic display device can notify the user that the stereoscopic image icon is focused by changing the color or shape of the stereoscopic image, vibrating the stereoscopic image, or providing a change in the sense of touch which the user has, and the 3Dimension stereoscopic display device can also notify the user that the stereoscopic image icon is operated by changing the color or shape of the stereoscopic image to a predetermined color or shape, vibrating the stereoscopic image, or providing a change in the sense of touch which the user has.

In above-mentioned Embodiment 1, a user operation of moving the user's finger can be an operation of moving a finger as if to draw a circle, a V-shaped checking operation of moving a finger as if to mark a checkbox, or an operation of moving a finger up and down or rightward and leftward as long as the main CPU 4a can identify the user operation by using the detection information from the three-dimensional touch panel 22 which is a pointing object detection unit.

As an alternative, the 3Dimension stereoscopic display device enables the user to select a pattern from preset patterns as the user operation of moving the user's finger, or can provide a gesture registration mode in which the user is allowed to register his or her own gesture in the system and enables the user to perform a registered gesture as the above-mentioned user operation.

In addition, the 3Dimension stereoscopic display device can perform a control operation of not changing the focus position, which is determined via stereoscopic vision, of an icon corresponding to a function which is not permitted to be performed according to the state of the vehicle equipped with or holding the 3Dimension stereoscopic display device even when detecting a user operation on the icon. For example, as an example of the icon corresponding to a function which is not permitted to be performed according to the above-mentioned state of the vehicle, there can be an icon which does not accept the operation assigned thereto because of restrictions on operations at a time when the vehicle is travelling. In this case, the 3Dimension stereoscopic display device can display the above-mentioned icon by changing the color and shape of the icon to a color and a shape different from those of icons corresponding to the functions which are permitted to be performed when the vehicle is travelling, or can send out a warning sound or a warning message when the user operates the icon. Further, the 3Dimension stereoscopic display device can change the color of an icon which is not permitted to be operated to gray, make the icon semi-transparent, or reduce the degree of projection with which the icon looks as if it is projecting via stereoscopic vision.

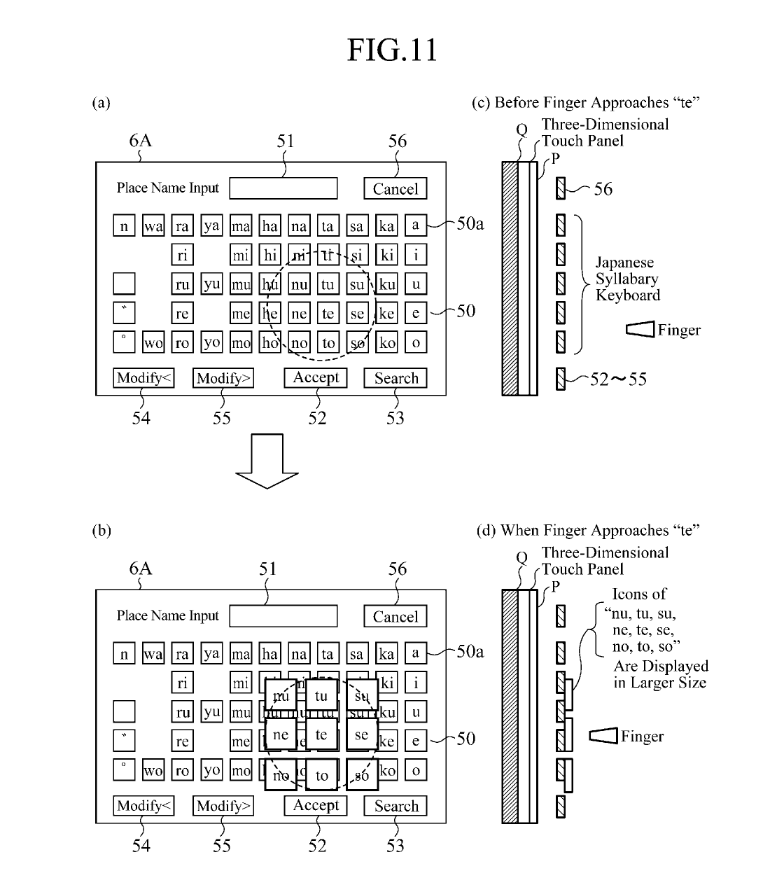

Further, when the user's finger approaches an icon, the 3Dimension stereoscopic display device in accordance with above-mentioned Embodiment 1 can display icons existing in a fixed region surrounding the finger in a larger size, thereby making it easy for the user to operate any one of the icons. FIG. 11 is a view showing an example 2 of the display of stereoscopic image icons according to a user operation, and shows a case in which a screen 6A for input of a place name including a Japanese syllabary software keyboard for input of a place name is displayed in a three-dimensional stereoscopic manner. FIGS. 11(a) and 11(b) are top plan views of the screen 6A for input of a place name, and FIG. 11(c) shows a virtual positional relationship between each button and the touch surface of the three-dimensional touch panel shown in FIG. 11(a). FIG. 11(d) shows a virtual positional relationship between each button and the touch surface of the three-dimensional touch panel shown in FIG. 11(b). In the example shown in FIG. 11, it is assumed that the screen Q of the stereoscopic display monitor 6, the touch surface of the three-dimensional touch panel 22, and the virtual display surface P of the planar image (the screen including an input character display box 51 which serves as a base) are placed at the same position.

As shown in FIGS. 11(a) and 11(c), the 3Dimension stereoscopic display device makes the screen 6A for input of a place name look as if character key buttons 50a in the Japanese syllabary keyboard 50, an accept button 52, a search button 53, modify buttons 54 and 55, and a cancel button 56 are floating from the screen including the input character display box 51 with respect to the user's position by using stereoscopic vision before the user performs a place name input operation. When the user's finger approaches the “te” button of the Japanese syllabary keyboard 50 and enters the detection region of the three-dimensional touch panel 22, the three-dimensional touch panel 22 outputs the coordinate data about the “te” character key button and character key buttons 50a existing adjacent to the “te” character key button which are enclosed by a dashed line shown in FIG. 11(a) to the screen composition processing unit 4.

When specifying the character key button 50a which the user's finger has approached and the character key buttons 50a existing adjacent to this character key button by using the coordinate data inputted thereto from the three-dimensional touch panel 22, the screen composition processing unit 4 generates a three-dimensional stereoscopic image in which these character key buttons 50a are displayed in a larger size, by a predetermined size, than that in which the other character key buttons 50a and the other various buttons 52 to 56 are displayed, and displays the three-dimensional stereoscopic image on the stereoscopic display monitor 6 via the video image playback device 5. As a result, as shown in FIG. 11(b) and FIG. 11(d), the “te” button which the user's finger has approached, and the “nu”, “tu”, “su”, “ne”, “se”, “no”, “to”, and “so” buttons existing adjacent to the “te” button are displayed in a larger size. By doing in this way, the 3Dimension stereoscopic display device can provide a legible and user-friendly character input screen.

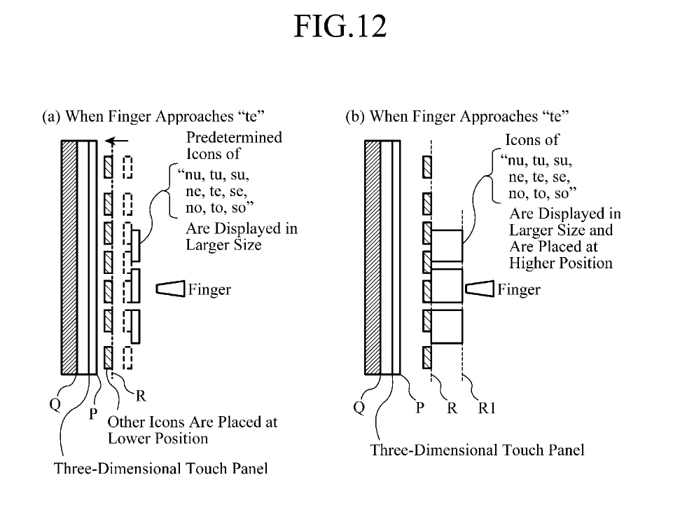

FIG. 12 is a view showing an example 3 of the display of the stereoscopic image icons according to a user operation, and shows another example of three-dimensional stereoscopic display of the screen 6A for input of a place name shown in FIG. 11 at a time when the user's finger approaches a character key button. In the example shown in FIG. 12(a), when the user's finger approaches the “te” character key button of the Japanese syllabary keyboard 50, the 3Dimension stereoscopic display device displays the “te” character key button and character key buttons 50a existing adjacent to this character key button in a larger size while reducing the degree of projection with which the icons showing the other buttons are projecting via stereoscopic vision. More specifically, the 3Dimension stereoscopic display device moves a virtual icon display surface R of the other buttons farther away from the user than the “te” character key button and the character key buttons 50a existing adjacent to this character key button to display the other buttons in such a way that they are focused farther away from the user than the “te” character key button and the character key buttons 50a existing adjacent to this character key button via stereoscopic vision. As a result, the 3Dimension stereoscopic display device highlights the display of the button which the user is going to operate and the buttons existing adjacent to this button when viewed from the user's position, and makes the screen become legible and makes it easy for the user to easily perform an input operation.

Further, when the user's finger approaches a character key button, the 3Dimension stereoscopic display device increases the degree of projection with which the character key button which the user's finger has approached and character key buttons 50a existing adjacent to this character key button are projecting via stereoscopic vision, as shown in FIG. 12(b). More specifically, the 3Dimension stereoscopic display device displays the character key button which the user's finger has approached and the character key buttons 50a existing adjacent to this character key button by using stereoscopic vision in such a way that they are floating closer to the user. At this time, the 3Dimension stereoscopic display device can display the icon images in such a way that they are extending from the icon display surface R of the other buttons, as shown in FIG. 12(b). More specifically, the 3Dimension stereoscopic display device displays the character key button which the user's finger has approached and the character key buttons 50a existing adjacent to this character key button on an icon display surface R1 which is placed closer to the user than the virtual icon display surface R of the icons showing the other buttons while changing the icon images to images that look as if they are extending from the icon display surface R. Even when doing in this way, the 3Dimension stereoscopic display device highlights the display of the button which the user is going to operate and the buttons existing adjacent to this button when viewed from the user's position, and makes the screen become legible and makes it easy for the user to easily perform an input operation.

Further, although the case in which a planar map is displayed in a stereoscopic manner is shown in above-mentioned Embodiment 1, the present invention can also be applied to a display of information, such as a menu screen for an AV system, vehicle information, or safety information, as long as the information is typical information displayed on the in-vehicle information system. For example, the present invention can be used for a display of an icon for control of an air conditioner, a meter panel in the dashboard, information about the fuel efficiency of the vehicle, preventive safety information, VICS (registered trademark) information, or the like.

In addition, although the case in which a stereoscopic display which is viewed stereoscopically with the naked eye is produced is shown in above-mentioned Embodiment 1, the present invention can also use a stereoscopic display method of providing a stereoscopic image by using a polarization eyeglass. Further, although in Embodiment 1 an optical type three-dimensional touch panel for detecting that a finger or a pointing object reaches a region at a distance of z3 or less from a touch surface is used as the three-dimensional touch panel, as shown in FIG. 4, a capacitance type touch panel capable of continuously detecting a distance z in the direction of the normal to the touch panel in an analog manner can be alternatively used. The present invention is not limited to the above-mentioned method as long as the position of a finger or a pointing object in three-dimensional space can be detected. For example, the 3Dimension stereoscopic display device can detect the position of a finger or a pointing object by performing image processing.

Although the case in which the 3Dimension stereoscopic display device in accordance with the present invention is applied to an in-vehicle information system is shown in above-mentioned Embodiment 1, the 3Dimension stereoscopic display device in accordance with the present invention can be applied to any display device having such a stereoscopic display monitor as above mentioned. For example, the 3Dimension stereoscopic display device in accordance with the present invention can be applied to not only an in-vehicle navigation device, but also a display device for use in a mobile telephone terminal or a mobile information terminal (PDA; Personal Digital Assistance). Further, the 3Dimension stereoscopic display device in accordance with the present invention can be applied to a display device, such as a PND (Portable Navigation Device) which a person carries onto a moving object, such as a car, a railroad, a ship, or an airplane, to use it.

The present invention is not limited to the structure explained in above-mentioned Embodiment 1. That is, it is to be understood that some of the structural components shown in above-mentioned Embodiment 1 can be freely combined, and a variation and an omission of each of the structural components can be made without departing from the spirit of scope of the invention.

### INDUSTRIAL APPLICABILITY

Because the 3Dimension stereoscopic display device in accordance with the present invention can provide an HMI with a three-dimensional stereoscopic display which enables the user to perform an operation matching the user's intuition, the 3Dimension stereoscopic display device is suitable for use as a display device mounted in an in-vehicle information system.

1-9. (canceled)

10. A 3Dimension stereoscopic display device comprising:
a stereoscopic display monitor unit for displaying a right-eye image or video image and a left-eye image or video image for three-dimensional stereoscopic display;
a touch panel unit for detecting a relative three-dimensional position of a pointing object relative to a touch surface thereof placed forward of a screen of said stereoscopic display monitor unit, said pointing object being used for performing a touch operation on a surface of the screen of said stereoscopic display monitor unit or said touch surface;
a screen composition processing unit for generating the right-eye image or video image and the left-eye image or video image for three-dimensional stereoscopic display in which a base screen which serves as a base of a screen display of said stereoscopic display monitor unit and a virtual display surface for three-dimensional stereoscopic display of an icon image which is an operation target are displayed at different screen positions in a three-dimensional stereoscopic manner; and
a control unit for determining that said icon image is operated when said touch panel unit detects a predetermined operation of said pointing object in a vicinity of three-dimensional space where said icon image is displayed in a three-dimensional stereoscopic manner.

11. The 3Dimension stereoscopic display device according to claim 10, wherein said screen composition processing unit generates the right-eye image or video image and the left-eye image or video image for three-dimensional stereoscopic display in which the virtual display surface for three-dimensional stereoscopic display of said icon image which is the operation target is displayed at a position forward with respect to the screen of said stereoscopic display monitor unit.

12. The 3Dimension stereoscopic display device according to claim 10, wherein when said touch panel unit detects that said pointing object exists in detection space thereof on said icon image during a predetermined time period or when said touch panel unit detects that said pointing object performs a predetermined operation in said detection space and in a vicinity of said detection space, said control unit determines that said icon image is operated.

13. The 3Dimension stereoscopic display device according to claim 12, wherein said predetermined operation is at least one of said pointing object's operation of pushing the touch surface, said pointing object's operation of drawing a locus having a predetermined shape, and said pointing objects operation of moving up and down or rightward and leftward.

14. The 3Dimension stereoscopic display device according to claim 12, wherein when said touch panel unit detects that said pointing object exists in the detection space thereof on said icon image, when said touch panel unit detects that said pointing object exists in said detection space during the predetermined time period, or when said touch panel unit detects that said pointing object performs said predetermined operation in said detection space and in the vicinity of said detection space, said control unit determines that said icon image is going to be operated, and said screen composition processing unit generates the right-eye image or video image and the left-eye image or video image for three-dimensional stereoscopic display in which a display of said icon image which said control unit determines is going be operated by said pointing object is changed.

15. The 3Dimension stereoscopic display device according to claim 14, wherein said screen composition processing unit changes at least one of a color and a shape of said icon image, and a position of the virtual display surface for three-dimensional stereoscopic display of said icon image.

16. The 3Dimension stereoscopic display device according to claim 14, wherein said screen composition processing unit enlarges said icon image which said control unit determines is going be operated by said pointing object, and another icon image existing within a predetermined region including said icon image, or generates the right-eye image or video image and the left-eye image or video image for three-dimensional stereoscopic display in which a position of the virtual display surface for three-dimensional stereoscopic display of said icon image is changed.

17. The 3Dimension stereoscopic display device according to claim 10, wherein said screen composition processing unit generates the right-eye image or video image and the left-eye image or video image for three-dimensional stereoscopic display in which the virtual display surface for three-dimensional stereoscopic display of the icon image which is the operation target on said operation screen is set to be placed at a position forward at a distance set by a user with respect to the screen of said stereoscopic display monitor unit.

18. The 3Dimension stereoscopic display device according to claim 10, wherein said screen composition processing unit generates the right-eye image or video image and the left-eye image or video image for three-dimensional stereoscopic display in which the virtual display surface for three-dimensional stereoscopic display of the icon image which is the operation target on said operation screen is set to be placed at a position forward at a distance predetermined according to a state of a moving object equipped with or holding said 3Dimension stereoscopic display device with respect to the screen of said stereoscopic display monitor unit.

19. The 3Dimension stereoscopic display device according to claim 18, wherein the distance predetermined according to the state of the moving object equipped with or holding said 3Dimension stereoscopic display device is predetermined according to a travelling speed of said moving object.

20. A navigation system comprising a 3Dimension stereoscopic display device including:
a stereoscopic display monitor unit for displaying a right-eye image or video image and a left-eye image or video image for three-dimensional stereoscopic display;
a touch panel unit for detecting a relative three-dimensional position of a pointing object relative to a touch surface thereof placed forward of a screen of said stereoscopic display monitor unit, said pointing object being used for performing a touch operation on a surface of the screen of said stereoscopic display monitor unit or said touch surface;
a screen composition processing unit for generating the right-eye image or video image and the left-eye image or video image for three-dimensional stereoscopic display in which a base screen which serves as a base of a screen display of said stereoscopic display monitor unit and a virtual display surface for three-dimensional stereoscopic display of an icon image which is an operation target are displayed at different screen positions in a three-dimensional stereoscopic manner; and
a control unit for determining that said icon image is operated when said touch panel unit detects a predetermined operation of said pointing object in a vicinity of three-dimensional space where said icon image is displayed in a three-dimensional stereoscopic manner,
wherein said navigation system accepts a touch operation by using said touch panel unit, and also produces a three-dimensional stereoscopic display of the image or video image for three-dimensional stereoscopic display by using said stereoscopic display monitor unit.

21. A navigation system connected to a stereoscopic display monitor unit for displaying a right-eye image or video image and a left-eye image or video image for three-dimensional stereoscopic display, and a touch panel unit for detecting a relative three-dimensional position of a pointing object relative to a touch surface thereof placed forward of a screen of said stereoscopic display monitor unit, said pointing object being used for performing a touch operation on a surface of the screen of said stereoscopic display monitor unit or said touch surface, for accepting a touch operation by using said touch panel unit, and also producing a three-dimensional stereoscopic display of the image or video image for three-dimensional stereoscopic display by using said stereoscopic display monitor unit, said navigation system comprising:
a screen composition processing unit for generating the right-eye image or video image and the left-eye image or video image for three-dimensional stereoscopic display in which a base screen which serves as a base of a screen display of said stereoscopic display monitor unit and a virtual display surface for three-dimensional stereoscopic display of an icon image which is an operation target are displayed at different screen positions in a three-dimensional stereoscopic manner; and
a control unit for deter mining that said icon image is operated when said touch panel unit detects a predetermined operation of said pointing object in a vicinity of three-dimensional space where said icon image is displayed in a three-dimensional stereoscopic manner.

22. The navigation system according to claim 20, wherein said screen composition processing unit generates the right-eye image or video image and the left-eye image or video image for three-dimensional stereoscopic display in which the virtual display surface for three-dimensional stereoscopic display of said icon image which is the operation target is displayed at a position forward with respect to the screen of said stereoscopic display monitor unit.

23. The navigation system according to claim 21, wherein said screen composition processing unit generates the right-eye image or video image and the left-eye image or video image for three-dimensional stereoscopic display in which the virtual display surface for three-dimensional stereoscopic display of said icon image which is the operation target is displayed at a position forward with respect to the screen of said stereoscopic display monitor unit.
